(19) United States
(12) Patent Application Publication
(10) Pub. No.: US 2014/0310741 A1
(43) Pub. Date: Oct. 16, 2014

(54) SYSTEM FOR SHARING DATA VIA CLOUD SERVER AND METHOD THEREOF

(71) Applicant: HON HAI PRECISION INDUSTRY CO., LTD., New Taipei (TW)

(72) Inventor: CHIH-HSIANG HU, New Taipei (TW)

(73) Assignee: HON HAI PRECISION INDUSTRY CO., LTD., New Taipei (TW)

(21) Appl. No.: 14/223,983

(22) Filed: Mar. 24, 2014

(30) Foreign Application Priority Data
Apr. 16, 2013 (CN) 2013101302095

(51) Int. Cl. H04N 21/258; H04N 21/27; H04N 21/64; H04N 21/475; H04N 21/426; H04N 21/218; H04N 21/45

(52) U.S. Cl. CPC H04N 21/25816; H04N 21/2181; H04N 21/27; H04N 21/4516; H04N 21/4753; H04N 21/42684; H04N 21/64
USPC 725/30

(57) ABSTRACT

A method for sharing data to a television device via cloud, includes: obtaining identification information of the television device when receiving a register request including the identification information of the television device from the television device. Sending a verification code to the television device according to a network address of the television device. Providing a verification code input interface for inputting the verification code, in response to a predetermined user operation on the electronic device. Determining whether the verification code input via the verification code input interface matches with the verification code sent to the television device. Associating identification information of the electronic device with the television device if yes. In addition, determining the television device associated with the electronic device in response to an operation to share data on the electronic device, and then transmits the data to be shared to the television device.

### BACKGROUND

1. Technical Field

The present disclosure relates to data sharing systems, and particularly to a system for sharing data with a television device via a cloud server and a method thereof.

2. Description of Related Art

Nowadays, a television device is a popular home appliance, and can connect to a cloud server to play or download network data, such as videos, pictures, provided by the cloud server through a set-top box. However, in general, data cannot be transmitted to the television device connected to the cloud server via a mobile phone, or other electronic devices.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of a system for sharing data to a television device via cloud server.

FIG. 2 is a schematic diagram of an embodiment of a running environment of the system of FIG. 1, including a cloud server, an electronic device, and a television device.

FIG. 3 is a schematic diagram of an embodiment of a verification code input interface.

FIG. 4 is a flowchart diagram of an embodiment of a method for sharing data to a television device via a cloud server.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the accompanying drawings.

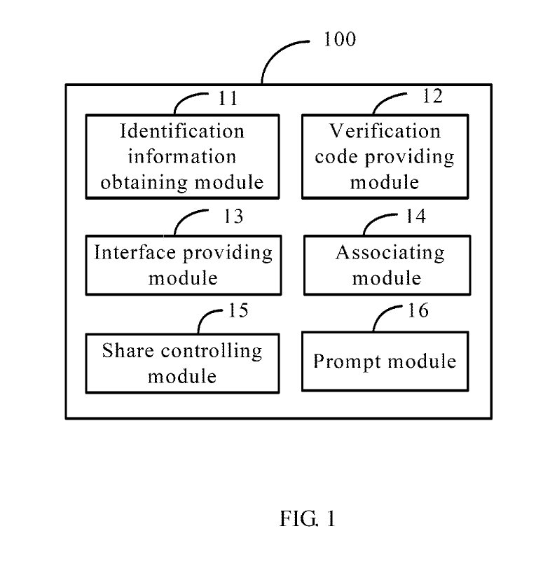

FIG. 1 shows an embodiment of a system 100 for sharing data via a cloud server. The system 100 includes an identification information obtaining module 11, a verification code providing module 12, an interface providing module 13, an associating module 14, and a share controlling module 15. In the embodiment, the modules of the system 100 are collection of software instructions executed by one or more processors.

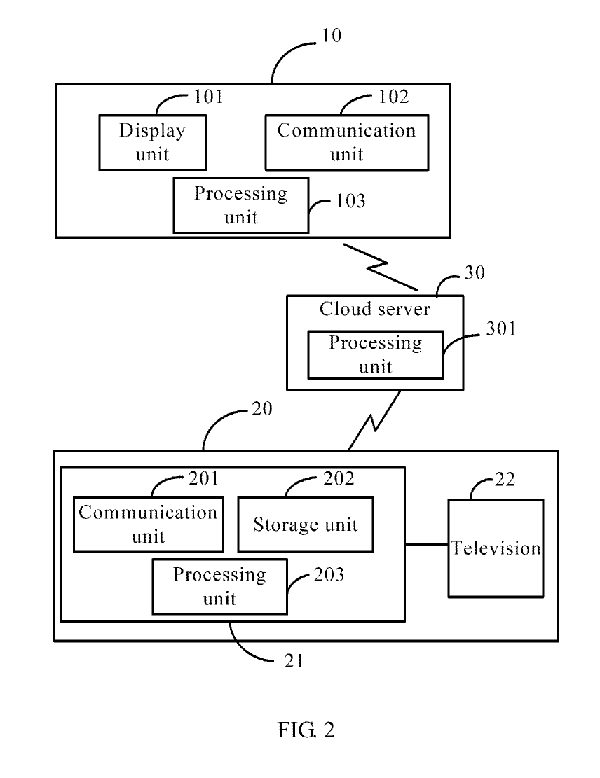

FIG. 2 shows that in the embodiment, the running environment of the system 100 includes an electronic device 10, a television device 20, and a cloud server 30. The electronic device 10 and the television device 20 are connected to the cloud server 30 via corresponding networks. The cloud server 30 provides data, including but not limited to, video files, image files, and audio files.

The electronic device 10 includes a display unit 101 and a communication unit 102. In the embodiment, the display unit 101 is a touch screen, in another embodiment, the display unit 101 can be a display screen and the display unit 101 combines a keyboard or a touchpad to constitute an input/output device. The electronic device 10 connects to the cloud server 30 through the network via the communication unit 102.

In the embodiment, the television device 20 includes a set-top box 21 and a television 22 connected to each other. The set-top box 21 includes a communication unit 201 and a storage unit 202. The set-top box 21 is connected to the cloud server 30 through the network via the communication unit 201. The television 22 connected to the set-top box 21 is taken as a display device to display television broadcasting signals received and decoded by the set-top box 21. In another embodiment, the television device 20 is a single device including the function of the set-top box 21 and the function of the television 22. Such as, the television device 20 can be a mobile phone with a function of playing television programs. In this embodiment, the television device 20 including the set-top box 21 and the television 22 is adopted as describe in the present disclosure.

The network among the cloud server 30, the electronic device 10, and the set-top box 21 can be an internet, an on-demand virtual lease line, a wireless network including WIFI and BLUETOOTH, a telecommunication network including a GPRS network, a CDMA network, or a broadcasting network. The network between the electronic device 10 and the cloud server 30 and the network between the cloud server 30 and the set-top box 21 can be the same or different. The networks can be public network or private network. The communication units 102, 201 can be communication chips complying with the corresponding networks.

In the embodiment, the electronic device 10 can be a mobile phone, a tablet computer, a portable computer, a desktop computer, for example. The cloud server 30 can be a physical machine, or a virtual machine. In the embodiment, the cloud server 30 also includes a processing unit 301, the electronic device 10 also includes a processing unit 103, the set-top box 20 also includes a processing unit 203. In the embodiment, the modules of the system 100 are all executed by the processing unit 301 of the cloud server 30. In another embodiment, the identification information obtaining module 11, the verification code providing module 12, and the share controlling module 15 are executed by the processing unit 301 of the cloud server 30, the interface providing module 13 is executed by the processing unit 103 of the electronic device 10 or the processing unit 203 of the set-top box 22, and the associating module 14 is executed by the processing unit 203 of the set-top box 22. The processing units 301, 103, and 203 can be central processing units, digital processors, single chips, and similar components.

The identification information obtaining module 11 is used to obtain identification information of one set-top box 21 when receiving a register request including the identification information of the set-top box 21 from the set-top box 21. The identification information includes a unique identifier and a network address of the set-top box 21. The unique identifier is used to identify the identity of the set-top box 21, the unique identifier can be a serial number of the set-top box 21, a MAC address of the set-top box 21. The network address of the set-top box 21 can be an Internet Protocol (IP) address, and other communication address. In detail, when a set-top box 21 is installed for one family for a first time, the set-top box 21 would send the register request including the identification information of the set-top box 21 to the cloud server 30. In another embodiment, the identification information obtaining module 11 also assigns an account number to the set-top box 21 and associates the account number with the unique identifier of the set-top box 21.

In another embodiment, when the television device 20 is the single device including the function of the set-top box 21 and the function of the television 22, the identification information obtained by the identification information obtaining module 11 is the identification information of the television device 20, and the identification information includes a unique identifier and a network address of the television device 20.

The verification code providing module 12 sends a predetermined verification code to the set-top box 21 according to the network address of the set-top box 21 when the identification information obtaining module 11 receives the register request including the identification information of the set-top box 21, thus displaying the verification code on the television 22.

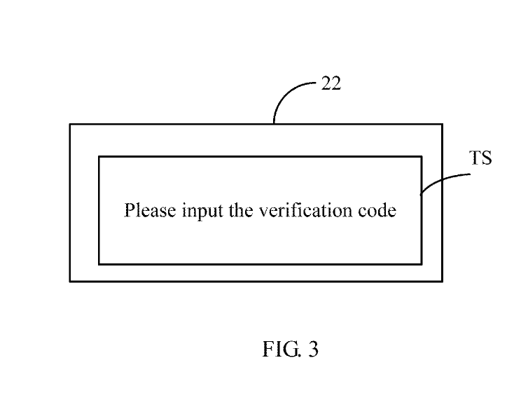

FIG. 3 shows that the interface providing module 13 is used to provide a verification code input interface TS for inputting the verification code and displaying the verification code input interface TS on the display unit 101 of the electronic device 10 in response to a predetermined user operation on the electronic device 10. In the embodiment, the predetermined user operation on the electronic device 10 is an operation to log in the cloud server 30 via the electronic device 10. In more detail, a related application software is installed in the electronic device 10, and the interface providing module 13 provides the verification code input interface TS in response to an operation of opening the application software, and then sends the verification code input by the user to the cloud server 30. Thus, when the television 22 displays the verification code provided by the verification code providing module 12, the user can input the verification code and send the verification code to the cloud server 30 according to the verification code displayed on the television 22.

In another embodiment, the interface providing module 13 provides the verification code input interface TS for inputting the verification code once the verification code providing module 12 provides the verification code and displays the verification code on the television 22.

The associating module 14 is used to determine whether the verification code input via the verification code input interface TS matches with the predetermined verification code provided by the verification code providing module 12, when receiving the verification code input via the verification code input interface TS on the electronic device 10. If the verification code input via the verification code input interface TS matches with the predetermined verification code provided by the verification code providing module 12, the associating module 14 associates identification information of the electronic device 10 with the unique identifier of the set-top box 21, thus binding the electronic device 10 and the set-top box 21. In the embodiment, the identification information of the electronic device 10 can be a telephone number, the associating module 14 associates the telephone number of the electronic device 10 with the account number of the set-top box 22. In another embodiment, the identification information of the electronic device 10 includes the telephone number and a user head image, the associating module 14 associates the telephone number of the electronic device 10 and the user head image with the account number of the set-top box 22. In the embodiment, the associating module 14 also sets the electronic device 10 inputting the correct verification code as an administrator. Thus, the electronic device 10 inputting the correct verification code is assigned an administrator right.

The share controlling module 15 is used to determine the set-top box 21 associated with the electronic device 10 in response to an operation to share data on the electronic device 10, and then transmits the data to be shared to the storage unit 202 of the determined set-top box 21, thus sharing the data to the set-top box 21 via the electronic device 10. For example, the electronic device 10 can log in the cloud server 30 via the account number of the set-top box 21, and then execute the operation to share the data of the electronic device 10. The share controlling module 15 then determines the set-top box 21 according to the account number. Here, the operation to share the data of the electronic device 10 is an operation to upload the data, which includes different types of media files to the cloud server 30.

In the embodiment, the storage unit 202 of the set-top box 21 is a local storage device included in the set-top box 21. The share controlling module 15 obtains the network address of the set-top box 21 associated with the electronic device 10 in response to the operation to share data on the electronic device 10, and transmits the data to the storage unit 202 of the set-top box 21 via the network address of the set-top box 21. In another embodiment, the storage unit 202 of the set-top box 21 can be a storage space in the cloud server 30 and is assigned to the set-top box 21 by the cloud server 30. The share controlling module 15 determines the set-top box 21 associated with the electronic device 10 in response to an operation to upload the data to the cloud server 30, and then uploads the data to the storage unit 202 of the set-top box 21 assigned by the cloud server 30.

Here, an icon corresponding to the storage unit 202 of the set-top box 21 is displayed on the television 22, and the user can access in the storage unit 202 of the set-top box 21 through operating the icon corresponding to the storage unit 202.

In the embodiment, the system 100 further includes a prompt module 16, the prompt module 16 is used to display a prompt signal on the television 22 when detecting new data to be shared to the storage unit 202 of the set-top box 21. For example, the prompt module 16 displays a prompt box to prompt the user who is in front of the television 22. Therein, when the identification information of the electronic device 10 includes the user head image, the prompt module 16 also display the user head image of the electronic device 10 sharing the data, thus indicating the person who shares the data. Herein, the processing unit 301 of the cloud server 30 or the processing unit 203 of the set-top box 22 can execute the prompt module 16.

In the embodiment, the associating module 14 also displays a prompt box on the electronic device 10 already associated with the set-top box 21, in response to a joining request from another electronic device 10, thus prompting the electronic device 100 associated with the set-top box 21 that whether to permit the joining request. In detail, the joining request sent by the other electronic devices 10 includes the telephone number of the electronic device 10 already associated with the set-top box 21. The associating module 14 then determines the electronic device 10 already associated with the set-top box 21 according to the telephone number of the electronic device 10 and displays the prompt box on the electronic device 10 already associated with the set-top box 21.

The associating module 14 further associates the electronic device 10 sending the joining request with the set-top box 21 when the electronic device 10 already associated with the set-top box 21 to permit the joining request. Thus, the electronic device 10 is now associated with the set-top box 21 also can share data to the set-top box 21.

In the embodiment, the electronic device 10 already associated with the set-top box 21 is only the electronic device 10 with the administrator right. In another embodiment, the electronic device 10 already associated with the set-top box 21 includes all of the electronic devices 10 associated with the set-top box 21.

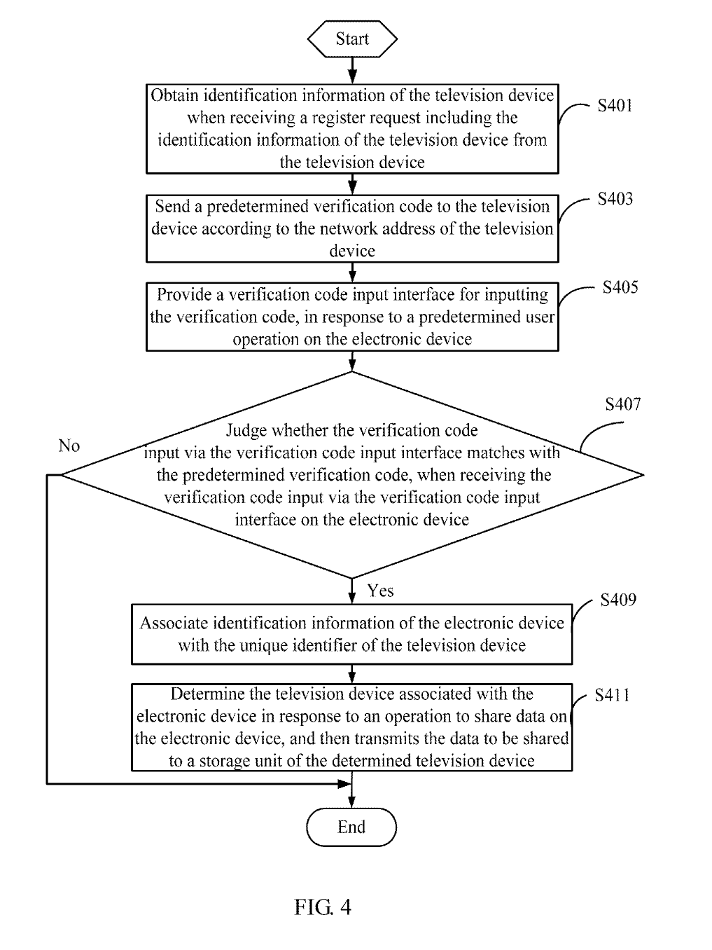

FIG. 4 is a flowchart diagram illustrating a method for sharing data to a set-top box 21 via cloud server. At first, the identification information obtaining module 11 obtains identification information of one set-top box 21 when receiving a register request including the identification information of the set-top box 21 from the set-top box 21, the identification information includes a unique identifier and a network address of the set-top box 21 (S401). Therein, the unique identifier is used to identify the identity of the set-top box 21. The unique identifier can be a serial number of the set-top box 21, a MAC address of the set-top box 21. The network address of the set-top box 21 can be an Internet Protocol (IP) address, and other communication addresses.

The verification code providing module 12 sends a predetermined verification code to the set-top box 21 according to the network address of the set-top box 21 and controls to display the verification code on the television 22 connected to the set-top box 21 (S403).

The interface providing module 13 provides a verification code input interface TS for inputting the verification code and displays the verification code input interface on the display unit 101 of the electronic device 10, in response to a predetermined user operation on the electronic device 10 (S405). In the embodiment, the predetermined user operation on the electronic device 10 is an operation to log in the cloud server 30 via the electronic device 10.

The associating module 14 determines whether the verification code input via the verification code input interface TS matches with the predetermined verification code provided by the verification code providing module 12, when receiving the verification code input via the verification code input interface TS on the electronic device 103 (S407). If yes, the procedure jumps to step S409, if not, the procedure is ended.

The associating module 14 associates the identification information of the electronic device 10 with the unique identifier of the set-top box 21, thus binding the electronic device 10 and the set-top box 21 (S409). In the embodiment, the identification information of the electronic device 10 can be a telephone number, the associating module 14 associates the telephone number of the electronic device 10 with the account number of the set-top box 22.

The share controlling module 15 determines the set-top box 21 associated with the electronic device 10 in response to an operation to share data on the electronic device 10, and then transmits the data to be shared to the storage unit 202 of the determined set-top box 21 (S411).

In the embodiment, the method further includes steps: the prompt module 16 displays a prompt signal on the television 22 when detecting there is new data to be shared to the storage unit 202 of the set-top box 21.

In the embodiment, the method further includes steps: the associating module 14 displays a prompt box on the electronic device 10 already associated with the set-top box 21, in response to a joining request from another electronic device 10, thus prompting the electronic device 10 associated with the set-top box 21 that whether to permit the joining request; the associating module 14 further associates the electronic device 10 sending the joining request with the set-top box 21 when the electronic device 10 already associated with the set-top box 21 permits the joining request.

According to the system 100 and the method of the present disclosure, the user can send/share data to the set-top box 21 through cloud via the electronic device 10.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A system for sharing data via a cloud server, the system run in a running environment comprising at least one electronic device, at least one television device, and at least one cloud server connected to each other, the system comprising:
one or more processors, and
a plurality of modules which are collection of instructions executed by the one or more processors, the modules comprising:
an identification information obtaining module configured to obtain identification information of the television device when receiving a register request comprising the identification information of the television device from the television device, wherein, the identification information of the television device comprises a unique identifier and a network address of the television device;
an verification code providing module configured to send a predetermined verification code to the television device according to the network address of the television device when the identification information obtaining module receives the register request including the identification information of the television device;
an interface providing module configured to provide a verification code input interface for inputting a verification code and display the verification code input interface on a display unit of the electronic device, in response to a predetermined user operation on the electronic device;
an associating module configured to judge whether the verification code input via the verification code input interface matches with the predetermined verification code provided by the verification code providing module, when receiving the verification code input via the verification code input interface on the electronic device; and associate identification information of the electronic device with the unique identifier of the television device; and
a share controlling module configured to determine the television device associated with the electronic device in response to an operation to share data on the electronic device, and then transmit the data to be shared to a storage unit of the determined television device.

2. The system according to claim 1, wherein the modules of the system further comprises a prompt module configured to display a prompt signal on the television device when detecting there is new data to be shared to the storage unit of the television device.

3. The system according to claim 1, wherein the associating module is further configured to display a prompt box on the electronic device already associated with the television device, in response to a joining request from another electronic device, thus to prompt the electronic device associated with the television device that whether permitting the joining request; the associating module further associates the electronic device sending the joining request with the television device when the electronic device already associated with the television device permits the joining request.

4. The system according to claim 1, wherein the identification information of the electronic device comprises a telephone number, the associating module associates the telephone number of the electronic device with the unique identifier of the television device.

5. The system according to claim 2, wherein the identification information of the electronic device comprises a telephone number and a user head image, the associating module associates the telephone number of the electronic device and the user head image with the unique identifier of the television device, and the prompt module further displays the user head image of the electronic device sharing the data to indicate the person who shares the data when detecting there is new data to be shared to the storage unit of the television device.

6. The system according to claim 1, wherein the predetermined user operation on the electronic device is an operation to log in the cloud server via the electronic device.

7. The system according to claim 1, wherein the storage unit of the television device is a local storage device included in the television device, the share controlling module obtains the network address of the television device associated with the electronic device in response to the operation to share data on the electronic device, and transmits the data to the storage unit of the television device via the network address of the television device.

8. The system according to claim 1, wherein the storage unit of the television device is a storage space in cloud and assigned to the television device by the cloud server, the share controlling module determines the television device associated with the electronic device in response to an operation to upload the data to the cloud server, and then uploads the data to the storage unit of the television device assigned by the cloud server.

9. A method for sharing data to a television device via cloud server, comprising:
obtaining identification information of the television device when receiving a register request comprising the identification information of the television device from the television device, wherein, the identification information of the television device comprises a unique identifier and a network address of the television device;
sending a predetermined verification code to the television device according to the network address of the television device;
providing a verification code input interface for inputting the verification code and displaying the verification code input interface on a display unit of an electronic device, in response to a predetermined user operation on the electronic device;
judging whether the verification code input via the verification code input interface matches with the predetermined verification code sent to the television device, when receiving the verification code input via the verification code input interface on the electronic device;
associating identification information of the electronic device with the unique identifier of the television device if yes; and
determining the television device associated with the electronic device in response to an operation to share data on the electronic device, and then transmits the data to be shared to a storage unit of the determined television device.

10. The method according to claim 9, further comprising:
displaying a prompt signal on the television when detecting there is new data to be shared to the storage unit of the television device.

11. The method according to claim 9, further comprising:
displaying a prompt box on the electronic device already associated with the television device, in response to a joining request from another electronic device, thus to prompt the electronic device associated with the television device that whether permitting the joining request; and
associating the electronic device sending the joining request with the television device when the electronic device already associated with the television device permits the joining request.

12. The method according to claim 9, wherein the step of displaying a prompt signal on the television when detecting there is new data to be shared to the storage unit of the television device comprises:
displaying a user head image of the electronic device sharing the data to indicate the person who shares the data.

13. The method according to claim 9, wherein the step of providing a verification code input interface for inputting the verification code and displaying the verification code input interface on a display unit of an electronic device, in response to a predetermined user operation on the electronic device comprises:
providing a verification code input interface for inputting the verification code and displaying the verification code input interface on the display unit of the electronic device, in response to an operation to log in a cloud server via the electronic device.
